(19) United States
(12) Patent Application Publication
(10) Pub. No.: US 2024/0326799 A1
(43) Pub. Date: Oct. 3, 2024

(54) METHOD AND CONTROL DEVICE FOR OPERATING A MOTOR VEHICLE

(71) Applicant: ZF Friedrichshafen AG, Friedrichshafen (DE)

(72) Inventors: Rachid Mansour, Markdorf (DE); Thomas Ascher, Amtzell (DE); Manuel Riß, Pfaffenhofen a.d. Roth (DE); Freddy Josef Frombach, Eriskirch (DE); Maik Würthner, Markdorf (DE)

(73) Assignee: ZF Friedrichshafen AG, Friedrichshafen (DE)

(21) Appl. No.: 18/573,693

(22) PCT Filed: Jun. 21, 2022
(86) PCT No.: PCT/EP2022/066782

§ 371 Date: Dec. 22, 2023

(30) Foreign Application Priority Data
Jun. 24, 2021 (DE) 10 2021 206 541.4

(51) Int. Cl. B60W 30/14; B60W 30/18; B60W 30/182; B60W 50/00

(52) U.S. Cl. CPC B60W 30/143; B60W 30/18072; B60W 30/182; B60W 50/0097; B60W 2030/1809; B60W 2556/50

(57) ABSTRACT

Disclosed is a method for operating a motor vehicle having a drive aggregate and a transmission. If the transmission is torque-transmitting, a cruise-control function is active, and a cruise-control target speed has been specified, then based on travelling route data about a travelling route ahead of the motor vehicle, a forecast speed profile is calculated. A maximum deviation between the cruise-control target speed and the forecast speed profile is determined, and as a function of this maximum deviation, a maximum permissible time duration for rolling or coasting operation is determined. It is checked whether the forecast speed profile would revert to the cruise-control target speed within the maximum permissible time duration, and if so, the rolling or coasting operating mode is activated. If the forecast speed profile would not revert to the cruise-control target speed within the maximum permissible time duration, the rolling or coasting operating mode remains deactivated.

### RELATED APPLICATIONS

This application claims the benefit under 35 U.S.C. § 371 as a U.S. National Phase Application of application no. PCT/EP2022/066782, filed on 21 Jun. 2022, which claims the benefit of German Patent Application no. 10 2021 206 541.4, filed on 24 Jun. 2021, the contents of which are hereby incorporated herein by reference in their entireties.

### FIELD OF THE DISCLOSURE

The invention relates to a method for operating a motor vehicle. The invention also relates to a control unit for operating a motor vehicle.

### BACKGROUND

From practice it is known that motor vehicles have a cruise-control function. A cruise-control function is a vehicle speed regulator which, during cruise-control operation of the motor vehicle, adjusts an actual speed of the motor vehicle to a specified cruise-control target speed. In this case a transmission of the motor vehicle is in torque-transmitting mode.

From practice it is also known that when a cruise-control function and thus cruise-control operation is active in the case of a torque-transmitting transmission, an automatic change to rolling or coasting operation of the motor vehicle can take place, wherein during such rolling or coasting operation of the motor vehicle its transmission is not torque-transmitting. For that, an automatic freewheel function has to be activated.

From EP 2 148 800 B1 a method is known for extending the active duration of an automatic freewheel function in a motor vehicle with a speed controller and during a time period when the speed controller is active. The speed controller is the cruise-control function. A method is disclosed, with the help of which the active duration of the rolling or coasting operation can be extended.

### SUMMARY

It has been found in practice, that the automatic commencement of rolling or coasting operation of the motor vehicle starting from an active cruise-control function is not very well accepted by drivers, so that an automatic freewheel function of that type is only very rarely used by drivers. This is particularly the case with utility vehicles such as trucks. Therefore, a need exists for a new type of method for operating a motor vehicle, with which, from an active cruise-control function, a change can be made automatically to rolling or coasting operation, and which is more readily accepted by drivers.

From this starting point, the purpose of the present invention is to provide a new type of method and a control unit for operating a motor vehicle.

This objective is achieved by a method for operating a motor vehicle according to the present disclosure.

The method for operating a motor vehicle with a drive aggregate and a transmission has the following steps:

When the transmission is torque-transmitting, when a cruise-control function is active, and when a cruise-control target speed has been specified, then on the basis of travelling route data relating to a travelling route ahead of the motor vehicle, a forecast speed profile is calculated, which would occur for a rolling or coasting motor vehicle in which the transmission is not torque-transmitting.

A maximum deviation between the cruise-control target speed and the forecast speed profile is determined.

As a function of this maximum deviation between the cruise-control target speed and the forecast speed profile, a maximum permissible time duration for rolling or coasting operation of the motor vehicle is determined.

It is checked whether, within the maximum permissible time duration for rolling or coasting operation, the forecast speed profile will revert to the cruise-control target speed.

If it is found, within the maximum permissible time duration, that the forecast speed profile would revert to the cruise-control target speed, then rolling or coasting operation is activated. On the other hand, if it is found within the maximum permissible time duration that the forecast speed profile would not revert to the cruise-control target speed, then rolling or coasting operation remains deactivated.

With the present invention a method is proposed, with which the maximum deviation between the cruise-control target speed and the forecast speed profile is determined and as a function thereof a maximum permissible time duration for the rolling or coasting operation is determined. Only when it is found that the forecast speed variation occurring for rolling or coasting operation would revert to the cruise-control target speed within the maximum permissible time, does an automatic change take place to rolling or coasting operation from an active cruise-control function or an active cruise-control operation. On the other hand, if that is not the case, then rolling or coasting operation remains deactivated. With such functionality, the motor vehicle can be prevented from persisting too long in rolling or coasting operation which has been started automatically from an active cruise-control function, and therefore from decelerating too much. In that way the acceptance of an automatic freewheel function by a driver is increased.

Preferably, the maximum permissible time duration begins from a time when the forecast speed profile deviates from the cruise-control target speed by more than a certain threshold value. In that way the driver's acceptance of the method can be improved still more. The maximum permissible time duration of rolling or coasting operation begins from a time when the forecast speed profile deviates from the cruise-control target speed for a longer time than the threshold value, i.e., when a speed reduction caused by the rolling or coasting operation would actually be perceived by a driver.

Preferably, the maximum permissible time duration of rolling or coasting operation is the shorter; the larger is the deviation between the cruise-control target speed and the forecast speed profile. On the other hand, the maximum permissible time duration for rolling or coasting operation is the longer; the smaller is the maximum deviation between the cruise-control target speed and the forecast speed profile. This too serves to improve a driver's acceptance of an automatic freewheel function.

Preferably the motor vehicle is a utility vehicle, in particular a truck. The method can be used to particularly good advantage with utility vehicles.

The control unit according to the invention is also disclosed herein. The control unit is designed to carry out the method according to the invention in an automated or automatic manner.

### BRIEF DESCRIPTION OF THE DRAWINGS

Preferred further developments emerge from the sole FIGURE and from the following description. Example embodiments of the invention, to which it is not limited, are explained in greater detail with reference to the drawing, which shows:

FIG. 1 is the sole FIGURE and shows a plot of velocity versus time, in accordance with an embodiment of the present disclosure.

### DETAILED DESCRIPTION

The invention relates to a method for operating a motor vehicle, in particular a utility vehicle such as a truck. In addition, the invention relates to a control unit for carrying out the method.

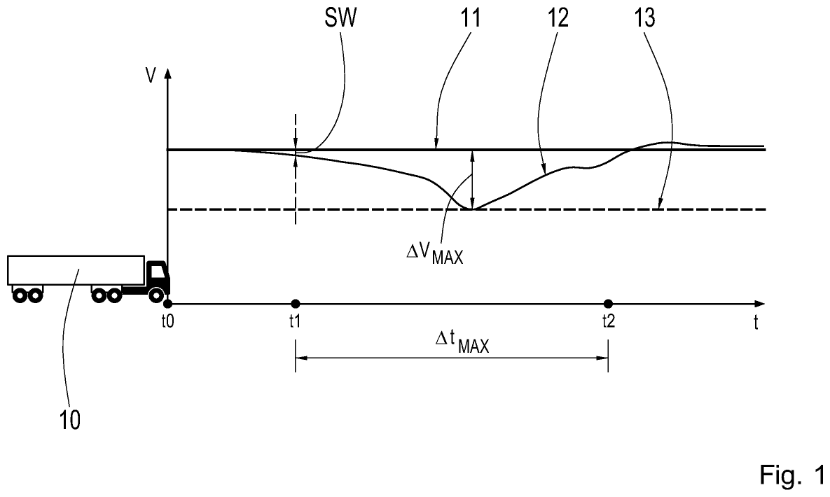

Below, the invention will be described with reference to the diagram shown in FIG. 1. In FIG. 1, a motor vehicle in the form of a truck 10 is shown, which should be operated with the help of the invention.

Over time t, time-variations of the speed v are plotted. Thus, the curve 11 visualizes a variation of a cruise-control target speed. When a cruise-control function and cruise-control operation are active, the cruise-control target speed is specified and a transmission of the motor vehicle 10 is torque-transmitting.

The curve of the variation 12 visualizes a forecast speed profile which would occur if the motor vehicle 10 were rolling or coasting. During rolling or coasting, the transmission of the motor vehicle 1 is not torque-transmitting. The curve 13 shows the minimum forecast speed during the rolling or coasting.

At time-point t0 it is assumed that in the motor vehicle 10 a cruise-control function is active, the vehicle is in cruise-control operation, and by virtue of the cruise-control function a cruise-control target speed is specified. When the cruise-control function is active during cruise-control operation, the cruise-control regulates the actual speed of the motor vehicle 10 to the cruise-control target value, and during this the transmission of the motor vehicle 10 is torque-transmitting, so that a drive torque produced by a drive aggregate of the motor vehicle can be transmitted via the transmission to the drive output of the motor vehicle 10.

Furthermore, it is assumed that at time to an automatic freewheel function is activated by the driver, which enables the initiation of rolling or coasting operation of the motor vehicle starting from the active cruise-control function or starting from cruise-control operation. During rolling or coasting operation of the motor vehicle, the transmission of the motor vehicle 10 is not torque-transmitting, so no drive torque can be delivered from the drive aggregate to the drive output.

An automatic freewheel function that enables the initiation of rolling or coasting operation of the motor vehicle, starting from a cruise-control function or cruise-control operation, is also called an undershoot function.

Accordingly at time 10 the motor vehicle drives in cruise-control operation and the activated automatic freewheel function or undershoot function with the transmission in torque-transmitting mode, so that the cruise-control adjusts the actual speed of the motor vehicle 10 to the cruise-control target speed.

Moreover, at time t0, on the basis of travelling route data relating to a travelling route ahead of the motor vehicle, the forecast speed profile 12 is calculated, which would occur with the rolling or coasting motor vehicle 10, i.e., when the transmission of the motor vehicle 10 during rolling or coasting operation would not be torque-transmitting, along the travelling route lying ahead of the motor vehicle 10.

Depending on the forecast speed profile 12 determined and the cruise-control target speed 11, a maximum deviation Δ_{VMAX} between the cruise-control target speed 11 and the forecast speed profile 12 is determined, which would occur if the motor vehicle 10 were to be operated in a rolling or coasting mode.

As a function of this maximum deviation Δ_{VMAX} between the cruise-control target speed 11 and the forecast speed profile 12, a maximum permissible time duration Δt_{MAX} for the rolling or coasting operation of the motor vehicle is determined.

This maximum permissible duration Δt_{MAX} begins at time-point t1 in FIG. 1, namely, when at time t1 the forecast speed profile deviates from the cruise-control target speed 11 by more than a threshold value SW.

According to the invention, it is checked whether, within the maximum permissible duration Δt_{MAX} of the rolling or coasting operation of the motor vehicle 10, the forecast speed profile 12 determined on the basis of the travelling route data ahead of the motor vehicle 10, reverts to the cruise-control target speed 11.

In FIG. 1 this is the case. In FIG. 1 the forecast speed profile 12 reverts to the cruise-control target speed 11 by time t2, and this takes place while the motor vehicle 10 is rolling or coasting with a transmission that is not torque-transmitting.

If it is found that the forecast speed profile 12 reverts to the cruise-control target speed 11 within the maximum permissible time Δt_{MAX}, then starting from the active cruise-control function the rolling or coasting operation is activated so that the cruise-control operation is then deactivated and the change to rolling or coasting operation takes place automatically.

This happens at time t1, namely when the actual speed of the motor vehicle 10 at that time deviates from the cruise-control target speed 11 by more than the threshold value.

On the other hand, if it is found that the forecast speed profile 12 does not revert to the cruise-control target speed 11 within the maximum permissible time Δt_{MAX}, then the cruise-control operation remains active and rolling or coasting operation remains deactivated.

The maximum permissible duration Δt_{MAX} of rolling or coasting operation, which is determined as a function of the maximum deviation Δ_{VMAX} between the cruise-control target speed 11 and the forecast speed profile 12, is the shorter: the larger is the maximum deviation Δ_{VMAX} between the cruise-control target speed 11 and the forecast speed profile 12. On the other hand, this maximum permissible duration Δt_{MAX} of rolling or coasting operation is the longer; the smaller is the maximum deviation Δ_{VMAX} between the cruise-control target speed 11 and the forecast speed profile 12.

Thus, in the context of the present invention, depending on the maximum difference between the forecast speed profile 12 and the cruise-control target speed 11, a maximum duration Δt_{MAX} for the rolling or coasting operation of the motor vehicle. i.e., for falling below the cruise-control target speed 11, has to be determined. Depending on this, it is determined whether a change will take place from cruise-control operation to rolling or coasting operation. In that way, a driver's acceptance of the automatic initiation of rolling or coasting operation from cruise-control operation is increased.

The travelling route data about the travelling route lying ahead of the motor vehicle 10 can be provided by a GPS system.

The invention also relates to a control unit for operating a motor vehicle having a drive aggregate and a transmission, the motor vehicle 10 preferably being a utility vehicle such as a truck.

The control unit according to the invention is designed to carry out the above-described method in an automated or automatic manner.

So when the motor vehicle 10 is driving in cruise-control operation with an active cruise-control function and a specified cruise-control target speed, and basically an initiation of an undershoot function is acceptable, then on the basis of travelling route data about the travelling route ahead of the motor vehicle 10 the control unit determines the forecast speed profile 12 that would occur if the motor vehicle 10 were rolling or coasting with its transmission not in torque-transmitting operation.

The control unit then determines the maximum deviation Δ_{VMAX} between the cruise-control target speed 11 and the forecast speed profile 12. As a function of this maximum deviation Δ_{VMAX} the control unit determines a maximum permissible time duration Δt_{MAX} for the rolling or coasting operation of the motor vehicle and checks whether, if the motor vehicle were to be in rolling or coasting operation, the forecast speed profile 12 would revert to the cruise-control target speed within the maximum permissible time as a result of the rolling or coasting operation.

Only if it is found that the forecast speed profile 12 would revert to the cruise-control target speed within the maximum permissible time Δt_{MAX}, is the rolling or coasting operation activated from the cruise-control operating mode, so that the cruise-control operation is deactivated.

After the lapse of the maximum permissible time Δt_{MAX} the transmission is changed again to the torque-transmitting condition, the rolling or coasting operation is terminated, and cruise-control operation is resumed.

The control unit that carries out the method according to the invention is preferably a transmission control unit.

This comprises hardware means and software means for carrying out the method according to the invention. The hardware means include data interfaces for the exchange of data with the assemblies involved in carrying out the method according to the invention, such as the transmission, in order to change it from a torque-transmitting condition to a non-torque-transmitting condition and, vice-versa, from a non-torque-transmitting condition to a torque-transmitting condition. The hardware means also include a processor for data processing and a memory for data storage. The software means include program modules implemented in the control unit for carrying out the method according to the invention.

### Indexes

10 Motor vehicle
11 Cruise-control target speed
12 Forecast speed profile
13 Minimum forecast speed

1-10. (canceled)

11. A method for operating a motor vehicle (10) having a drive aggregate and a transmission, the method comprising:
calculating a forecast speed profile when the transmission is torque-transmitting, a cruise-control function is active, and a cruise-control target speed (11) has been specified, a forecast speed profile (12), wherein the speed profile is based on travelling route data about a travelling route ahead of the motor vehicle (10) and the speed profile would occur when the motor vehicle (10) is rolling or coasting with its transmission in a non-torque-transmitting condition;
determining a maximum deviation (Δ_{VMAX}) between the cruise-control target speed (11) and the forecast speed profile (12);
determining a maximum permissible time duration (Δt_{MAX}) for rolling or coasting operation of the motor vehicle, the maximum permissible time duration based on the maximum deviation (Δ_{VMAX});
checking whether, within the maximum permissible duration (Δt_{MAX}) for rolling or coasting operation, the forecast speed profile (12) would revert to the cruise-control target speed (11); and
operating the rolling or coasting mode based on the result of checking.

11. The method of claim 10, comprising:
determining that the forecast speed profile (12) would revert to the cruise-control target speed (11) within the maximum permissible time (Δt_{MAX}); and
activating the rolling or coasting operating mode.

12. The method according to claim 11, wherein the maximum permissible time duration (Δt_{MAX}) begins from when the forecast speed profile (12) deviates from the cruise-control target speed (11) by more than a threshold value (SW).

13. The method according to claim 12, wherein the maximum permissible duration (Δt_{MAX}) for the rolling or coasting operation of the motor vehicle is the shorter and the larger is the maximum deviation (Δ_{VMAX}) between the cruise-control target speed (11) and the forecast speed profile (12).

14. The method according to claim 12, wherein the maximum permissible duration (Δt_{MAX}) for the rolling or coasting operation of the motor vehicle is the longer and the smaller is the maximum deviation (Δ_{VMAX}) between the cruise-control target speed (11) and the forecast speed profile (12).

15. The method of claim 10, comprising:
determining that forecast speed profile (12) would not revert to the cruise-control target speed (11) within the maximum permissible time (Δt_{MAX}); and
maintaining deactivation of the rolling or coasting operating mode.

16. The method according to claim 15, wherein the maximum permissible time duration (Δt_{MAX}) begins from when the forecast speed profile (12) deviates from the cruise-control target speed (11) by more than a threshold value (SW).

17. The method according to claim 15, wherein the maximum permissible duration (Δt_{MAX}) for the rolling or coasting operation of the motor vehicle is the shorter and the larger is the maximum deviation (Δ_{VMAX}) between the cruise-control target speed (11) and the forecast speed profile (12).

17. The method according to claim 15, wherein the maximum permissible duration (Δt_{MAX}) for the rolling or coasting operation of the motor vehicle is the longer and the smaller is the maximum deviation (Δ_{VMAX}) between the cruise-control target speed (11) and the forecast speed profile (12).

18. The method according to claim 10, wherein the motor vehicle (10) is a utility vehicle.

19. The method according to claim 18, wherein the utility vehicle is a truck.

20. A control unit for operating a motor vehicle (10) having a drive aggregate and a transmission, the control unit configured to carry out a method comprising:
calculating a forecast speed profile when the transmission is torque-transmitting, a cruise-control function is active, and a cruise-control target speed (11) has been specified, a forecast speed profile (12), wherein the speed profile is based on travelling route data about a travelling route ahead of the motor vehicle (10) and the speed profile would occur when the motor vehicle (10) is rolling or coasting with its transmission in a non-torque-transmitting condition;
determining a maximum deviation (Δ_{VMAX}) between the cruise-control target speed (11) and the forecast speed profile (12);
determining a maximum permissible time duration (Δt_{MAX}) for rolling or coasting operation of the motor vehicle, the maximum permissible time duration based on the maximum deviation (Δ_{VMAX});
checking whether, within the maximum permissible duration (Δt_{MAX}) for rolling or coasting operation, the forecast speed profile (12) would revert to the cruise-control target speed (11); and
operating the rolling or coasting mode based on the result of checking.

21. The control unit of claim 20, wherein the method further comprises:
determining that the forecast speed profile (12) would revert to the cruise-control target speed (11) within the maximum permissible time (Δt_{MAX}); and
activating the rolling or coasting operating mode.

22. The control unit according to claim 21, wherein the maximum permissible time duration (Δt_{MAX}) begins from when the forecast speed profile (12) deviates from the cruise-control target speed (11) by more than a threshold value (SW).

23. The control unit according to claim 22, wherein the maximum permissible duration (Δt_{MAX}) for the rolling or coasting operation of the motor vehicle is the shorter and the larger is the maximum deviation (Δ_{VMAX}) between the cruise-control target speed (11) and the forecast speed profile (12).

24. The control unit according to claim 22, wherein the maximum permissible duration (Δt_{MAX}) for the rolling or coasting operation of the motor vehicle is the longer and the smaller is the maximum deviation (Δ_{VMAX}) between the cruise-control target speed (11) and the forecast speed profile (12).

25. The control unit of claim 20, wherein the method further comprises:
determining that forecast speed profile (12) would not revert to the cruise-control target speed (11) within the maximum permissible time (Δt_{MAX}); and
maintaining deactivation of the rolling or coasting operating mode.

26. The control unit according to claim 25, wherein the maximum permissible time duration (Δt_{MAX}) begins from when the forecast speed profile (12) deviates from the cruise-control target speed (11) by more than a threshold value (SW).

27. The control unit according to claim 25, wherein the maximum permissible duration (Δt_{MAX}) for the rolling or coasting operation of the motor vehicle is the shorter and the larger is the maximum deviation (Δ_{VMAX}) between the cruise-control target speed (11) and the forecast speed profile (12).

28. The control unit according to claim 25, wherein the maximum permissible duration (Δt_{MAX}) for the rolling or coasting operation of the motor vehicle is the longer and the smaller is the maximum deviation (Δ_{VMAX}) between the cruise-control target speed (11) and the forecast speed profile (12).

29. The control unit according to claim 20, wherein the control unit is configured to carry out the method in an automated or automatic manner.
